(19) United States
(12) Patent Application Publication
(10) Pub. No.: US 2017/0006832 A1
(43) Pub. Date: Jan. 12, 2017

(54) TOY FOR HIDE-AND-SEEK INTERACTION WITH CATS

(71) Applicant: TONGFU MANUFACTURING CO., LTD, Nanjing (CN)

(72) Inventor: Yaoming MA, Nanjing (CN)

(21) Appl. No.: 14/940,273

(22) Filed: Nov. 13, 2015

(30) Foreign Application Priority Data
Jul. 10, 2015 (CN) 201520495878.7

(51) Int. Cl. A01K 15/02

(52) U.S. Cl. CPC A01K 15/025

(57) ABSTRACT

The present disclosure provides a toy for hide-and-seek interaction with cats. The toy has a crank arm, one end of which is secured with a toy member while the other end in secured on a disc face of a gear having a center secured on a motor shaft, and a shell on which a through hole is formed. The toy member is exposed outside the shell via the through hole; and a photoresistor is further provided on the shell. The photoresistor is connected to an integrated circuit and controls the rotation of a motor through the integrated circuit. In this way, the photoresistor acts as a trigger component. When a cat approaches, the motor is actuated by the photoresistor to drive the toy member.

### TECHNICAL FIELD OF THE INVENTION

The utility model relates to a toy for hide-and-seek interaction with cats, belonging to the field of toys for pets.

### BACKGROUND OF THE INVENTION

Cats are common pets in families. In order to increase interaction with cats, those skilled in the art have been committed to research and development of toys for pets, which may attract pet cats and meet the instinct of cats.

It was found that a cat has a natural preference for items such as wool and feather. However, such items are mostly too loose in structure, and consequently, a large amount of floating sundries will be generated when a cat is playing with them.

### SUMMARY OF THE INVENTION

An objective of the present invention is to develop a toy for pets, which may meet requirements of a cat while playing with it and avoid floating sundries falling from the loose items during playing, on the basis of the preference of a cat for such items such as wool and feather.

In order to achieve the objective of the present invention, a toy for hide-and-seek interaction with cats is disclosed, including a crank arm, one end of which is secured with a toy member while the other end in secured on a disc face of a gear having a center secured on a motor shaft, and further including a shell, on which a through hole is formed, the toy member being exposed outside the shell via the through hole; and a photoresistor is further provided on the shell, the photoresistor being connected to an integrated circuit and controlling the rotation of a motor through the integrated circuit.

The integrated circuit is designed in the same existing integration way. A control program for a motor may be preset in the integrated circuit. When a signal indicating that the photoresistor is shielded is transmitted to the integrated circuit, the integrate circuit controls the motor to rotate at different frequencies according to the preset program, so that the gear rotates at different speeds, thus to drive the crank arm secured on the disc face of the gear to rotate. Accordingly, the toy member secured at the other end of the crank arm moves within a sector. The toy member protrudes from the shell when rotating to a high point of the sector, while enters the shell from a through hole when rotating to a low point of the sector. In this way, the hide-and-seek effect is realized.

Preferably, a suction cup socket is further provided on the bottom of the shell. With this suction cup socket, a suction cup may be inserted into this toy, so that the stability of the entire device is improved. This ensures a stable position of this toy when a cat is playing with it.

Further preferably, a loudspeaker hole is further provided on the bottom of the shell. Correspondingly, a loudspeaker is integrated on the integrated circuit so that the interestingness is improved.

More preferably, a gear is further provided; the gear is secured with the motor shaft to together form a driving gear, and engaged with a gear secured by the crank arm; and the radius of the driving gear is greater than that of the gear secured by the crank arm. Thus, it seems that the gear rotates in variable speeds. The amplitude of swinging of the toy member in increased, and accordingly, the interestingness is improved.

Meanwhile, the toy member is preferably a bundle of feather, and accordingly, the crank arm secures the bundle of feather by a securing insert tube. The interactivity and entertainment are improved based on the preference of a cat for feather.

Finally, the shell is preferably an egg-shaped shell having a horizontal bottom plate. In this way, the surface of the shell is a smooth egg-shaped cambered surface, which feels well and gives much entertainment during the hide-and-seek.

In the present utility model, the photoresistor is regarded as a trigger component, and when a cat approaches, the motor is actuated by the photoresistor to drive the toy member, especially the bundle of feather, to irregularly move upward, downward, leftward and rightward within a sector, in order to realize the hide-and-seek effect. This toy may significantly attract pet cats and improve the interactivity and interestingness.

### BRIEF DESCRIPTION OF THE DRAWINGS

FIG. 1 is a schematic diagram of a toy for hide-and-seek interaction with cats;

FIG. 2 is a schematic diagram of a bottom of the toy for hide-and-seek interaction with cats; and

FIG. 3 is a schematic diagram of an interior of the toy for hide-and-seek interaction with cats.

### DETAILED DESCRIPTION OF THE INVENTION

In order to describe the present utility model better, technical solutions of the present utility model will be further described below with reference to the accompanying drawings.

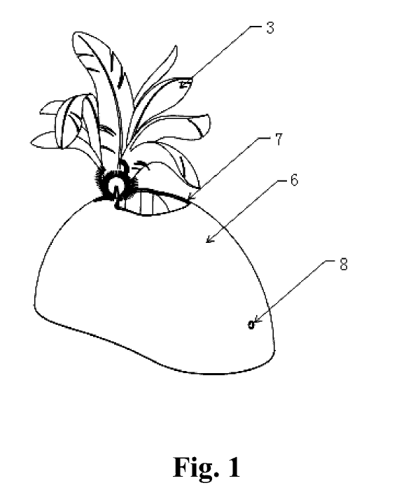

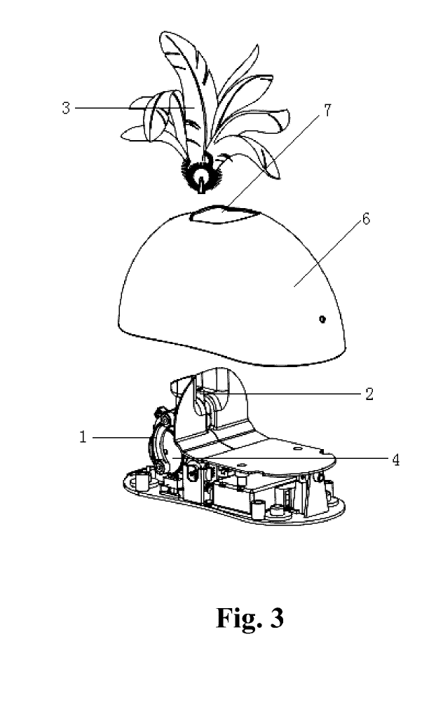

Referring to the FIG. 1 to FIG. 3, a toy for hide-and-seek interaction with cats is disclosed. First, FIG. 3 shows a crank arm 1, one end of which is secured with a securing insert tube 2, and a bundle of feather 3 is inserted into the securing insert tube 2 to form a moving body together with the crank arm 1. As can be seen, the other end of the crank arm 1 is secured on a disc face of a gear 4 having a center secured on a motor shaft. An egg-shaped shell 6 having a bottom plate 5 is further included, with a through hole 7 formed on the shell. FIG. 1 is a view when this toy is completely assembled. As shown, the bundle of feather 3 is exposed outside the shell 6 via the through hole 7, and a photoresistor 8 is further provided on the shell 6.

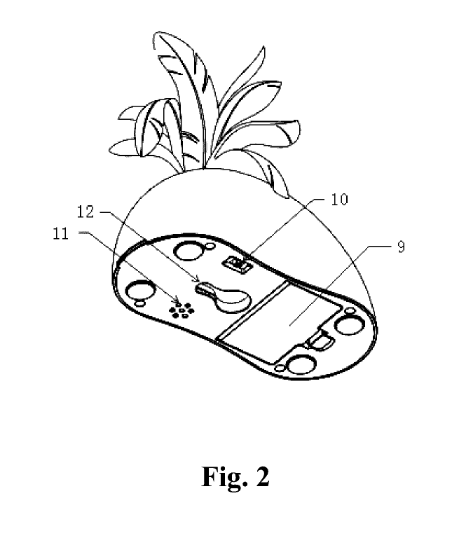

Meanwhile, referring to FIG. 2, in order to effectively power this toy, a cell box 9 and a power switch 10 are provided, so that electronic components such as the photoresistor, the integrated circuit and the motor may be selectively powered if desired.

Of course, preferably, FIG. 2 further shows a loudspeaker hole 11 which realizes sounding together with the loudspeaker in the internal circuit.

When a cat approaches, interference with the photoresistor 8 is caused, and the photoresistor 8 is thus triggered and actuates the motor by the integrated circuit; then, the motor begins to rotate according to a program preset in the integrated circuit to drive the gear 4 to rotate and to drive the crank cram 1 to move circumferentially, so as to form the movement of the bundle of feather within a sector. With the irregular appearance and disappearance of the egg-shaped shell 6, the hide-and-seek effect is realized.

Preferably, referring to FIG. 2, a suction cup socket 12 is further provided on the bottom, so that a suction cup may be inserted into the suction cup socket 12 to stably secure this toy to the ground.

1. A toy for hide-and-seek interaction with cats, comprising a crank arm, one end of which is secured with a toy member while the other end is secured on a disc face of a gear having a center secured on a motor shaft, and further comprising a shell on which a through hole is formed, the toy member being exposed outside the shell via the through hole; and a photoresistor is further provided on the shell, the photoresistor being connected to an integrated circuit and controlling the rotation of a motor through the integrated circuit.

2. The toy for hide-and-seek interaction with cats according to claim 1, characterized in that a suction cup socket is further provided on the bottom of the shell.

3. The toy for hide-and-seek interaction with cats according to claim 1, characterized in that a loudspeaker hole is further provided on the bottom of the shell and a loudspeaker is integrated on the integrated circuit.

4. The toy for hide-and-seek interaction with cats according to claim 1, characterized in that a gear is further provided; the gear is secured with the motor shaft to together form a driving gear, and engaged with a gear secured by the crank arm; and the radius of the driving gear is greater than that of the gear secured by the crank arm.

5. The toy for hide-and-seek interaction with cats according to claim 1, characterized in that the toy member is a bundle of feather, and the crank arm secures the bundle of feather by a securing insert tube.

6. The toy for hide-and-seek interaction with cats according to claim 1, characterized in that the shell is an egg-shaped shell having a horizontal bottom plate.
